(19) United States
(12) Patent Application Publication
(10) Pub. No.: US 2026/0081390 A1
(43) Pub. Date: Mar. 19, 2026

(54) MULTI-DIRECTIONAL NETWORK SOCKET

(71) Applicant: JYH ENG TECHNOLOGY CO., LTD., NEW TAIPEI CITY (TW)

(72) Inventors: YEN-LIN LIN, NEW TAIPEI CITY (TW); MENG-JU LEE, NEW TAIPEI CITY (TW)

(21) Appl. No.: 19/182,608

(22) Filed: Apr. 18, 2025

(30) Foreign Application Priority Data
Sep. 18, 2024 (TW) 113210106

(51) Int. Cl. H01R 24/64; H01R 13/447; H01R 13/506; H01R 13/66; H01R 43/26; H01R 107/00

(52) U.S. Cl. CPC H01R 24/64; H01R 13/447; H01R 13/506; H01R 13/6658; H01R 43/26; H01R 2107/00; H01R 2201/04

(57) ABSTRACT

A multi-directional network socket includes a front casing, a rear casing, a circuit board module, a first cover, a flip cover, a second cover and a wiring cover. An end of the front casing is provided with a jack, the front casing is assembled with the rear casing to form an accommodation space, such that the jack communicates with the accommodation space, and the first and second covers are pivoted on the rear casing to define a covering state. The snap-on combination of the first and second covers allows the socket to be opened without using special tools and avoiding inadvertent opening of the socket, and the structural design of the flip cover movably installed to the first cover further provides on-site construction workers with more flexibility in space adjustment during construction, and the multi-directional network socket provides good dustproof and waterproof effects.

### CROSS-REFERENCE TO RELATED APPLICATIONS

This non-provisional application claims priority under 35 U.S.C. § 119(a) on Patent Application No(s). 113210106 filed in Taiwan, R.O.C. on Sep. 18, 2024, the entire contents of which are hereby incorporated by reference.

### BACKGROUND OF THE DISCLOSURE

### Technical Field

The present disclosure relates to the field of network communication equipment, and particularly relates to a multi-directional network socket with a first cover and a second cover which can be opened and closed, and its snap-on combination allows the socket to be opened without using special tools and avoiding inadvertent opening of the socket. In addition, the design of a flip cover movably installed to the first cover further provides on-site construction workers with more flexibility in space adjustment during construction, and the multi-directional network socket provides good dustproof and waterproof effects.

### Description of the Related Art

In the past, most network signal jacks of a keystone jack type had a cable outlet configured in a fixed single direction, which was usually a horizontal backward direction after installation. However, in practice, the horizontal backward cable outlet often encounters space constraints. Especially, when the network cable plug is installed, the network cable will be installed on the wall panel, and the length of the network socket inside a junction box is almost equal to the length from the panel to the bottom of the junction box. On-site construction workers could only try an alternative way to connect the network cables by inserting them from the left and right sides of the junction box, which is limited by the fact that the network cable has to be bent at 90 degrees and then assembled into the network socket. Since the 90-degree bends have no radius of curvature, and when the network signals are transmitted, the smaller the radius of curvature of the network cables, the greater the impact on the transmission rate of the signal and the tendency to cause the signal to be scattered. For the current network cables which have 8 transmission core wires inside, and the bending of each core wire will cause signal scattering, resulting in signal crossing each other and lowering the network transmission rate.

Therefore, there are many network sockets on the market with direct side outlets to avoid the problem of bending the cables, but it also caused various different problems, such as: when two network sockets are placed side by side, these sockets with the same direction of wire outlets will interfere with each other. If two network signal outlets are arranged side by side, and the openings of the two network sockets are facing two different directions, then the network cables will enter the junction box on the same side and exit on the same side. If it is necessary to change the network socket on another side to the same side, we need to bend the signal cable 180 degrees, which may result in the scattering of the electromagnetic waves and lead to the lowering of the network transmission rate. In applications, the network sockets of this kind are mostly used in the network system. If they are used in general machine rooms, they do not need to use the side outlet design, and become unable to be used universally. In addition, when construction workers work on site, the network transmission cable must first be threaded onto the wiring cover, but due to the pulling force, it may fall off easily and must be repositioned before installation. Such repeated adjustments will result in the problem of inefficiency in construction, and thus improvements are needed.

Therefore, the inventor of the present disclosure based on years of experience in the related industry to conduct research and experiment, and finally proposed a structural design of the multi-directional network socket in accordance with the present disclosure. In addition to the original front casing, rear casing, circuit board module, first cover, second cover and wiring cover, the present disclosure further adds a flip cover, and the plurality of piercing terminals of circuit board module is configured to be corresponsive to the wiring cover and provided with a pair of divider plates and a pair of wire separation structural plates, and a reinforced arch bridge is arranged between the pair of divider plates. This structural design is used to temporarily fix the network cable for subsequent assembly operations, thereby solving the shortcomings of the conventional construction and improving the construction efficiency.

### SUMMARY OF THE DISCLOSURE

The primary objective of the present disclosure is to provide a multi-directional network socket in accordance with the present invention, the multi-directional network socket includes a front casing, a rear casing, a first cover, a flip cover and a second cover, wherein the combination of the first cover and the second cover, and the structural design of the flip cover provides on-site construction workers with more flexibility in space adjustment, and the invention also provides good dustproof and waterproof effects. In addition, a circuit board module is installed in an accommodation space which is formed after the front casing and the rear casing are assembled, and a plurality of piercing terminals is provided corresponding to a network cable, and a pair of divider plates and a pair of wire separation structural plates are provided corresponding to the piercing terminals on a wiring cover to temporarily fix the network cable, thereby improving the convenience of the assembling.

To achieve the aforementioned objective, the present invention provides a multi-directional network socket used in a network system and provided to be installed in the network system, and the multi-directional network socket includes: a front casing, in the shape of a rectangular structure, and having a jack disposed at an end of the front casing, and a first pivot part and a second pivot part disposed at a rear end of the front casing, which is opposite to the end of the front casing, such that the first pivot part and the second pivot part are configured to be opposite to each other; a rear casing disposed at another end of the front casing to form an accommodation space, such that the jack and the accommodation space communicate with each other; a first cover installed to the first pivot part, and two sides of the first cover being provided with a blocking cover respectively, and a rear end of the first cover being provided with a threading hole next to the upper surface thereof; a flip cover movably pivoted to a side of the threading hole, so that the flip cover can be closed and opened relative to the threading hole; and a second cover installed to the second pivot part, and two sides of the second cover being respectively provided with a notch corresponding to each blocking cover, such that each blocking cover is precisely accommodated in each notch to define a closure when the first cover and the second cover are closed relative to the front casing.

### BRIEF DESCRIPTION OF THE DRAWINGS

FIG. 1 is an exploded view of a multi-directional network socket in accordance with a preferred embodiment of the present disclosure;

FIG. 2 is a perspective view of the multi-directional network socket in accordance with the preferred embodiment of the present disclosure, after it is assembled;

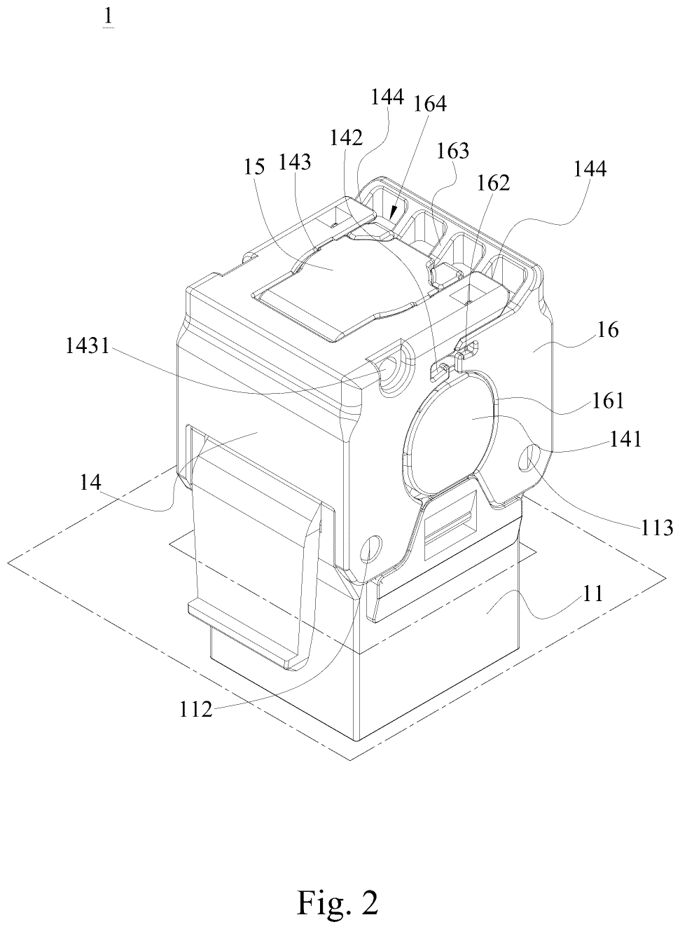

FIG. 3 is a partial cross-sectional view of the multi-directional network socket in accordance with the preferred embodiment of the present invention, when it is snapped and engaged;

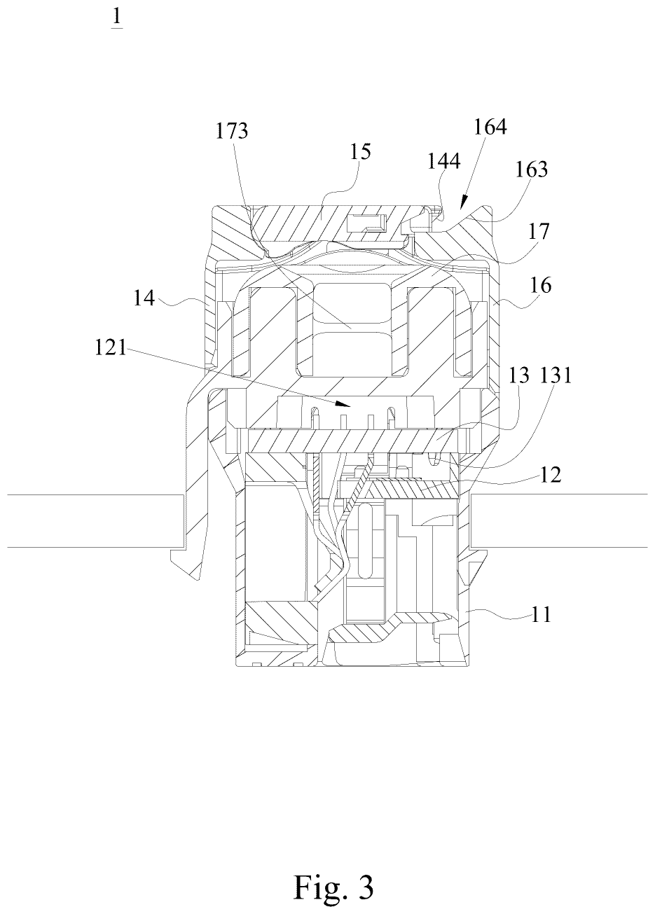

FIG. 4 is a first schematic view showing the state of the multi-directional network socket in accordance with the preferred embodiment of the present invention, when it is operated;

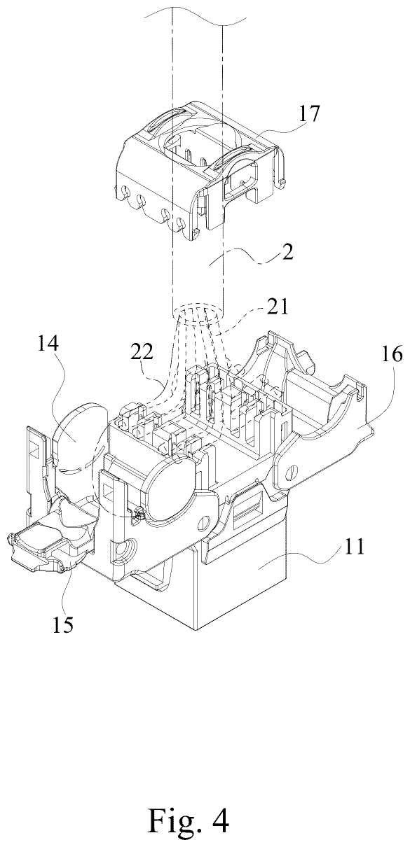

FIG. 5 is a second schematic view showing the state of the multi-directional network socket in accordance with the preferred embodiment of the present invention, when it is operated;

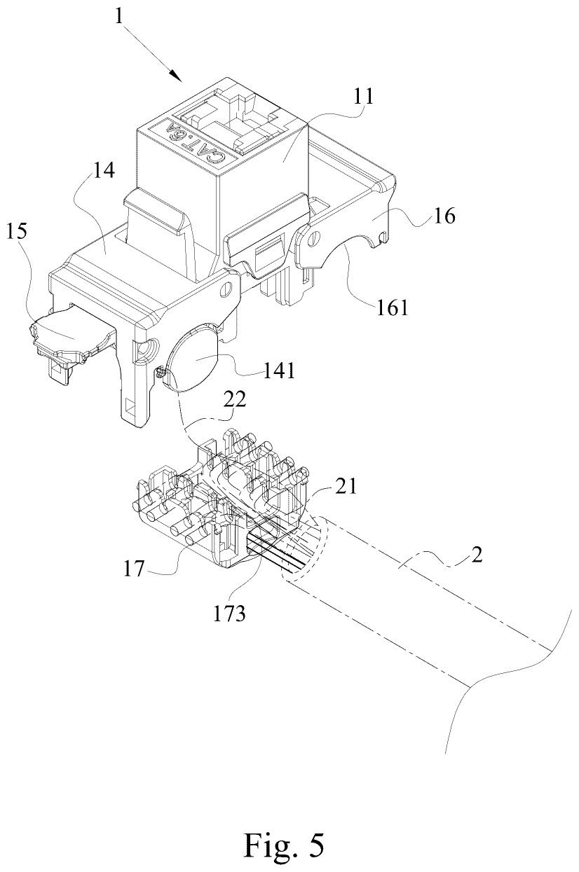

FIG. 6 is an exploded view of a multi-directional network socket in accordance with another preferred embodiment of the present invention;

FIG. 7 is a partial cross-sectional view of another preferred embodiment of the present invention, when it is snapped and engaged;

FIG. 8 is a first schematic view showing the structure of a wiring cover in accordance with a preferred embodiment of the present invention; and

FIG. 9 is a second schematic view showing the structure of a wiring cover in accordance with a preferred embodiment of the present invention.

### DESCRIPTION OF THE PREFERRED EMBODIMENTS

The following description together with the attached drawings are provided to enable our examiner to clearly understand the technical contents of the present disclosure.

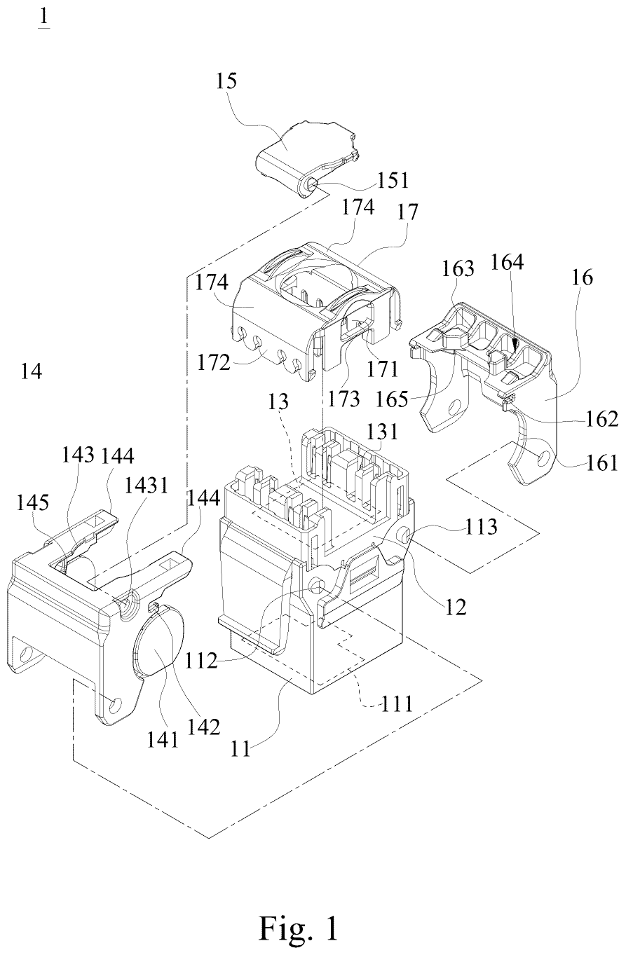

With reference to FIG. 1˜3, 4 and 5 for the exploded view, perspective view, and partial cross-sectional view of a multi-directional network socket and the schematic views showing various different operation statuses in accordance with a preferred embodiment of the present invention respectively, the multi-directional network socket 1 includes a front casing 11, a rear casing 12, a circuit board module 13, a first cover 14, a flip cover 15, a second cover 16 and a wiring cover 17, and the multi-directional network socket 1 is used in a network system.

The front casing 11 is in the shape of a rectangular structure, an end of the front casing 11 is provided with a jack 111, and a rear end of the front casing 11, which is opposite to the end of the front casing, is provided with a first pivot part 112 and a second pivot part 113, such that the first pivot part 112 and the second pivot part 113 are opposite to each other.

The rear casing 12 is arranged at another end of the front casing 11 to form an accommodation space 121, such that the jack 111 and the accommodation space 121 communicate with each other.

The circuit board module 13 is installed in the accommodation space 121, and the circuit board module 13 has eight piercing terminals 131 which corresponds to eight core wires 21 contained in a network cable 2, the piercing terminals 131 is arranged in two symmetrical rows with four piercing terminals on each side. It is noteworthy that the jack 111 of this embodiment corresponds to the type of a RJ45 network cable and has 8 elastic contacts which are configured to be corresponsive to the piercing terminals 131 respectively.

The first cover 14 is installed to the first pivot part 112, two sides of the first cover 14 are provided with a blocking cover 141, a first hook 142 is provided between the first cover 14 and the at least one blocking cover 141, and a rear end of the first cover 14 adjacent to the upper surface thereof is provided with a threading hole 143.

The flip cover 15 is pivoted to a side of the threading hole 143, so that the flip cover 15 can be closed and opened relative to the threading hole 143. In this embodiment, of the present invention, a pivot column 151 is provided, respectively, on two sides of the flip cover 15 and corresponding to the threading hole 143, and the threading hole 143 is provided with a pivot hole 1431 on two inner sides of the threading hole 143 respectively for movably pivoting the flip cover 15 into the threading hole 143.

The second cover 16 is installed to the second pivot part 113, and two sides of the second cover 16 are respectively provided with a notch 161 corresponding to each blocking cover 141, such that such that each blocking cover 141 is precisely accommodated in each notch 161 to define a closure when the first cover 14 and the second cover 16 are closed relative to the front casing 11, and a second hook 162 is provided between the second cover 16 and the at least one notch 161, such that the first hook 142 and the second hook 162 are opposite to each other. In addition, an anti-loosening means is formed at a position where the first cover 14 engages with the second cover 16 to prevent the first cover 14 from opening due to a misoperation, and the anti-loosening means includes a pair of oblique support arms 144 located on the first cover 14, and a relative inclined plane 163 located on the second cover 16, a step difference portion 164 located between the pair of oblique support arms 144 and the relative inclined plane 163 and corresponding to a flathead tool, so that the flathead tool can pass into the step difference portion 164 to pry open the first cover 14; and the first hook 142 and the second hook 162 are provided for installing a grounding wire 22 of the network cable 2.

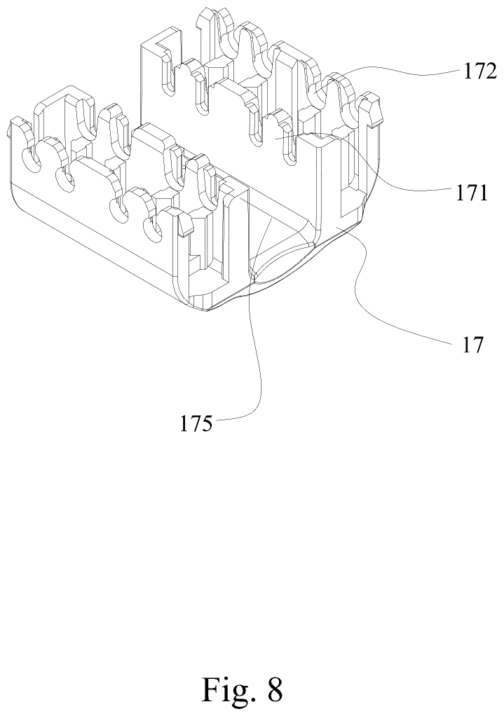

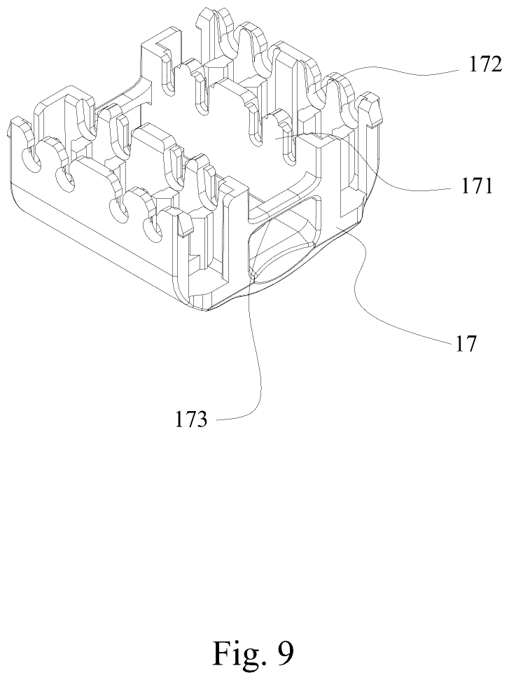

In FIG. 8, the wiring cover 17 of the present invention covers the rear casing 12, a divider plate 171 and a wire separation structural plate 172 are provided on two opposite sides of the wiring cover 17 and corresponding to the piercing terminals 131 respectively, and a through slot 175 is formed inside the wiring cover 17 for communicating with two opposite sides and passing the core wires 21 into the through slot 175 in order to be installed to the corresponding positions of each of the divider plates 171 and each of the wire separation structural plates 172 respectively. Each core wire 21 corresponds to each of the piercing terminals 131 for connection to form an electrical conduction, after the wiring cover 17 is installed in the accommodation space 121. As shown in FIG. 9, the other two opposite sides of the wiring cover 17 are provided with a reinforced arch bridge 173 respectively, the reinforced arch bridges 173 are arranged between the two divider plates 171, such that the reinforced arch bridge 173 corresponds to the core wires and is divided into two sections. Four core wires 21 pass through the space formed by the reinforced arch bridge 173, and the other four core wires 21 pass through the space outside the reinforced arch bridge 173 and are installed to the corresponding positions of each of the divider plates 171 and each of the wire separation structural plates 172 respectively. Finally, after the wiring cover 17 is installed in the accommodation space 121, each core wire 21 corresponds to each of the piercing terminals 131 for connection to form an electrical conduction. It is noteworthy that the top of the wiring cover 17 of the present invention is provided with a plurality of support parts 174, and the corresponding positions on the inner sides of the first cover 14 and the second cover 16 are provided with a plurality of arc support surfaces 145, 165, so that when the first cover 14 and the second cover 16 are closed inward, the arc support surfaces 145, 165 can be used to press against the support parts 174 to generate a force to suppress the core wires 21 to define a fixation.

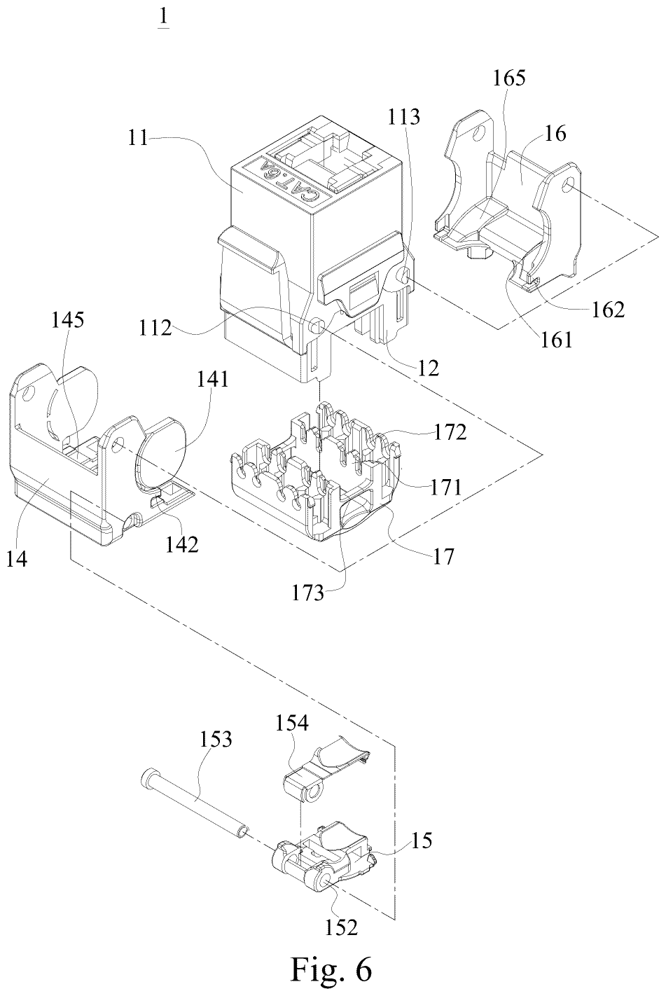

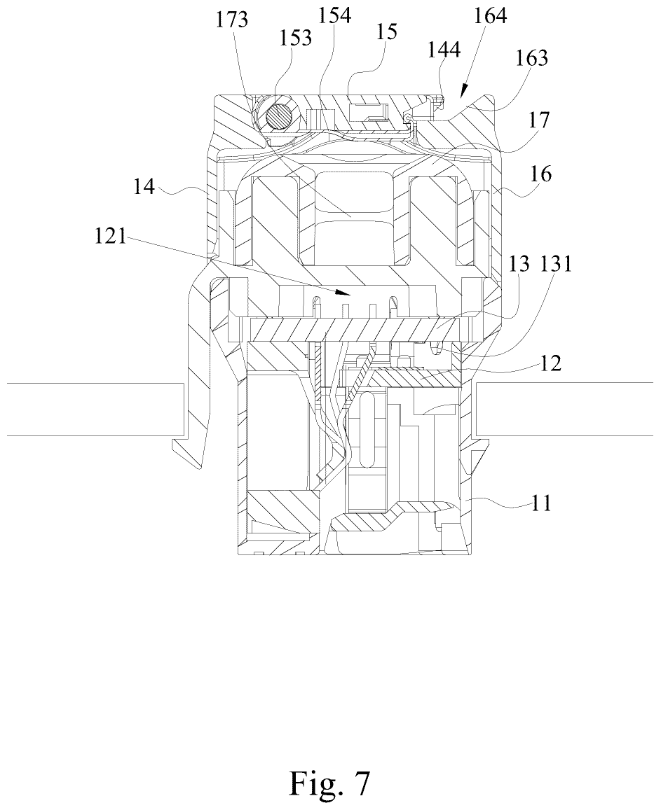

With reference to FIGS. 6 and 7 for the exploded view and the partial cross-sectional view of another preferred embodiment of the present invention respectively, two sides of the flip cover 15 corresponding to the threading hole 143 are respectively provided with a first pivot hole 152, two inner sides of the threading hole 143 are provided with a second pivot hole 1431, and a pivot column 153 is used to movably pivot the flip cover 15 into the threading hole 143, the inner side of the flip cover 15 is provided with a grounding part 154 for installing the grounding wire 22, and the grounding part 154 is selected from a metal sheet or a metal coating having an electrically conductive effect.

In summation of the description above, the multi-directional network socket 1 of the present invention includes the front casing 11, the rear casing 12, the circuit board module 13, the first cover 14, the flip cover 15, the second cover 16 and the wiring cover 17, and the multi-directional network socket 1 is installed in a network system and used for the purpose of connecting the network cable 2 of the network communication equipment, and installing the circuit board module 13 into the accommodation space 121 after the front casing 11 and the rear casing 12 are combined. The structural design of the wiring cover 17 adopts a side outlet for wiring which allows the four core wires 21 to pass through the space formed by the reinforced arch bridge 173, and the other four core wires 21 to pass through the space outside the reinforced arch bridge 173 and be installed at the corresponding positions of each of the divider plates 171 and each of the wire separation structural plates 172 respectively. By using this method as a means of temporarily fixing the network cable 2, the on-site construction workers do not have to readjust the positions of the core wires 21, thereby achieving the purpose of improving the convenience of assembly during on-site construction. In addition, the combination of the first cover 14 and the second cover 16 can prevent loosening and facilitate opening with hand tools, and the flip cover 15 can be repeatedly closed and opened, thus providing on-site construction workers with more flexibility in space adjustment, and the invention also provides good dustproof and waterproof effects.

What is claimed is:

1. A multi-directional network socket used in a network system and provided to be installed in the network system, the multi-directional network socket comprising:
a front casing, in a shape of a rectangular structure, comprising a jack disposed at an end of the front casing, and a first pivot part and a second pivot part disposed at a rear end of the front casing, which is opposite to the end of the front casing, such that the first pivot part and the second pivot part are opposite to each other;
a rear casing disposed at another end of the front casing to form an accommodation space such that the jack and the accommodation space communicate with each other;
a first cover installed to the first pivot part and two sides of the first cover being provided with a blocking cover, respectively, and a rear end of the first cover adjacent to an upper surface thereof being provided with a threading hole;
a flip cover movably pivoted to a side of the threading hole such that the flip cover capable of being closed and opened relative to the threading hole; and
a second cover installed to the second pivot part and two sides of the second cover being provided with a notch, respectively, corresponding to each blocking cover, such that each blocking cover is precisely accommodated in each notch to define a closure when the first cover and the second cover are closed relative to the front casing.

2. The multi-directional network socket according to claim 1, further comprising a circuit board module installed in the accommodation space and the circuit board module having eight piercing terminals which corresponds to eight core wires contained in a network cable, the eight piercing terminals being arranged in two symmetrical rows with four piercing terminals on each side, and the jack corresponding to a type of a RJ45 network cable and having 8 elastic contacts therein.

3. The multi-directional network socket according to claim 2, wherein an anti-loosening means is formed at a position where the first cover engages with the second cover to prevent the first cover from opening due to a misoperation.

4. The multi-directional network socket according to claim 3, wherein the anti-loosening means comprises a pair of oblique support arms located on the first cover, and a relative inclined plane located on the second cover, a step difference portion located between the pair of oblique support arms and the relative inclined plane and corresponding to a flathead tool, so that the flathead tool is capable of passing into the step difference portion to pry open the first cover.

5. The multi-directional network socket according to claim 4, wherein a first hook is provided between the first cover and at least one blocking cover, and a second hook is provided between the second cover and at least one notch, such that the first hook and the second hook are opposite to each other, and a grounding wire of the network cable is installed via the first hook and the second hook.

6. The multi-directional network socket according to claim 5, further comprising a wiring cover provided for covering the rear casing, wherein a divider plate and a wire separation structural plate are provided on two opposite sides of the wiring cover and corresponding to the eight piercing terminals, respectively, and a through slot is formed inside the wiring cover and communicating with the two opposite sides for passing the eight core wires into the through slot, and installed to corresponding positions of each of the divider plate and the wire separation structural plate, respectively, and each core wire corresponds to each of the eight piercing terminals for a connection to form an electrical conduction after the wiring cover is installed in the accommodation space.

7. The multi-directional network socket according to claim 6, wherein the wiring cover is provided with a plurality of support parts at a top thereof, and a plurality of arc support surfaces are provided at corresponding positions on inner surfaces of the first cover and the second cover, so that, when the first cover and the second cover are closed inward, the plurality of arc support surfaces is capable of being used to press against the plurality of support parts to generate a force to suppress the eight core wires to define a fixation.

8. The multi-directional network socket according to claim 2, further comprising a wiring cover for covering the rear casing, wherein a divider plate and a wire separation structural plate are provided on two opposite sides of the wiring cover and corresponding to the eight piercing terminals, respectively, and a reinforced arch bridge is provided on other two opposite sides of the wiring cover, respectively, such that the reinforced arch bridge corresponds to the eight core wires and is divided into two sections, four core wires pass through a space formed by the reinforced arch bridge, and another four core wires pass through a space outside the reinforced arch bridge, and the eight core wires are installed to corresponding positions of each of the divider plate and the wire separation structural plate, and each core wire corresponds to each of the eight piercing terminals for a connection to form an electrical conduction after the wiring cover is installed in the accommodation space.

9. The multi-directional network socket according to claim 8, wherein the wiring cover is provided with a plurality of support parts at a top thereof, and a plurality of arc support surfaces are provided at corresponding positions on inner surfaces of the first cover and the second cover, so that, when the first cover and the second cover are closed inward, the plurality of arc support surfaces is capable of being used to press against the plurality of support parts to generate a force to suppress the eight core wires to define a fixation.

10. The multi-directional network socket according to claim 2, wherein a pivot column is provided, respectively, on two sides of the flip cover and corresponding to the threading hole, and the threading hole is provided with a pivot hole on two inner sides thereof for movably pivoting the flip cover into the threading hole.

11. The multi-directional network socket according to claim 2, wherein the flip cover is provided with a first pivot hole on two sides thereof, respectively, and the first pivot hole is corresponding to the threading hole, and the threading hole is provided with a second pivot hole on two inner sides thereof, respectively, and a pivot column is provided for movably pivoting the flip cover into the threading hole.

12. The multi-directional network socket according to claim 11, wherein the flip cover is provided with a grounding part on an inner side thereof, for installing a grounding wire of the network cable.

13. The multi-directional network socket according to claim 12, wherein the grounding part is one selected from a metal sheet or a metal coating.
